(19) United States
(12) Patent Application Publication
(10) Pub. No.: US 2026/0139140 A1
(43) Pub. Date: May 21, 2026

(54) GRANULES AND METHODS OF MAKING

(71) Applicant: CERTAINTEED LLC, Malvern, PA (US)

(72) Inventors: Anvay Arun PATIL, Downington, PA (US); Devin J. SOLIWODA, Coatesville, PA (US); Erin Lynn CAMPONESCHI BROTHERSON, Avondale, PA (US)

(21) Appl. No.: 19/389,554

(22) Filed: Nov. 14, 2025

Related U.S. Application Data
(60) Provisional application No. 63/721,222, filed on Nov. 15, 2024.

(51) Int. Cl. C09C 1/36

(52) U.S. Cl. CPC C09C 1/3661; C01P 2002/82; C01P 2004/61; C01P 2004/62; C01P 2004/88; C01P 2006/62; C01P 2006/63; C01P 2006/64

(57) ABSTRACT

A granule may include a coating disposed over at least a portion of a core. The coating may include composite particles contained in an oxide-containing binder. The composite particles may include titanium-containing particles dispersed in an oxide-containing composition. In a particular embodiment, the oxide-containing composition of the composite particles may include an alkaline earth element.

### CROSS-REFERENCE TO RELATED APPLICATION(S)

This application claims priority under 35 U.S.C. § 119(e) to U.S. Provisional Patent Application No. 63/721,222, entitled “GRANULES AND METHODS OF MAKING,” filed Nov. 15, 2024, by Anvay Arun PATIL et al., which is assigned to the current assignee hereof and is incorporated herein by reference in its entirety.

### BACKGROUND

### Field of the Disclosure

The present disclosure relates generally to granules having a coated core and method of making the same, and in particular, to granules that may be used in various building applications such as roofing products.

### Technical Background

One significant environmental stress a shingled roof can experience is the elevated temperature to which roofing shingles are subjected under sunny, summer conditions. The surface reflectivity of an asphalt shingle largely depends on the solar reflectance of roofing granules that are used to cover the bitumen. Roofing granules typically comprise crushed and screened mineral materials, which can be coated subsequently with a binder containing one or more suitable metal oxides. Roofing granules may also add aesthetic values to a roof. There is a continuing need for roofing materials that have improved resistance to thermal stresses while providing an attractive appearance.

### BRIEF SUMMARY OF INVENTION

This summary is provided to introduce a selection of concepts that are further described below in the detailed description. This summary is not intended to identify indispensable features of the claimed subject matter, nor is it intended for use as an aid in limiting the scope of the claimed subject matter.

In an embodiment, a granule may include a core and a coating disposed over at least a portion of the core, wherein the coating comprises composite particles dispersed in an oxide-containing binder, wherein the composite particles comprise titanium-containing particles contained in an oxygen-containing binder including an alkaline earth metal.

In another embodiment, a granule may include a core and a coating disposed over at least a portion of the core, wherein the coating comprises a) composite particles dispersed in an oxide-containing binder, wherein the composite particles comprise titanium dioxide and at least one other oxygen-containing composition, and b) individual solar-reflective pigment particles dispersed in the oxide-containing binder.

In another embodiment, a process of preparing a granule may comprise forming a mixture including composite particles and a fluid carrier; applying the mixture to a surface of a core, wherein applying comprises spraying; and forming the granule including a coating overlying at least a portion of the core, wherein the coating may include the composite particles.

### BRIEF DESCRIPTION OF THE DRAWINGS

The present disclosure may be better understood, and its numerous features and advantages made apparent to those skilled in the art by referencing the accompanying drawings.

FIG. 1 schematically illustrates a substrate coated with granules according to an embodiment.

FIG. 2 shows a schematic perspective view of a portion of a roof according to an embodiment.

FIG. 3 shows a schematic cross-sectional view of a granule comprising a coating according to an embodiment.

FIG. 4 schematically illustrates a portion of the coating shown in FIG. 3 according to an embodiment.

FIG. 5 shows a flow chart illustrating a process for forming a granule according to an embodiment.

FIG. 6 shows a flow chart illustrating a process for forming a granule according to another embodiment.

Skilled artisans appreciate that elements in the figures are illustrated for simplicity and clarity and have not necessarily been drawn to scale. For example, the dimensions of some of the elements in the figures can be exaggerated relative to other elements to help improve understanding of embodiments of the invention. The use of the same reference symbols in different drawings indicates similar or identical items.

### DETAILED DESCRIPTION

The following description, in combination with the figures, is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises”, “comprising”, “includes”, “including”, “has”, “having”, or any other variation thereof are intended to cover a non-exclusive inclusion. For example, a process, method, article, or apparatus that comprises a list of features is not necessarily limited only to those features but can include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one, and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting.

Embodiments herein relate to granules having a core and a coating disposed over at least a portion of the core, wherein the coating can include composite particles. In an embodiment, the coating may have improved distribution of certain particles. In a further embodiment, the granules may be suitably used to coat a substrate and may provide improved total solar reflectance to the substrate. Embodiments may further relate to a method of forming the granules. In an embodiment, the method may include forming a mixture including composite particles and improved distributions of certain particles. The method may further include applying the coating to a core and heating the coated core at a controlled temperature to allow formation of granules with improved total solar reflectivity.

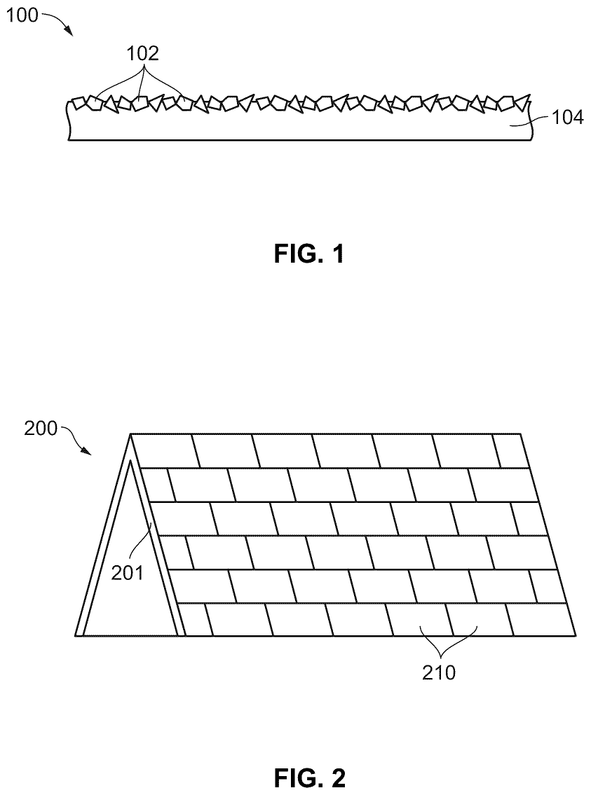

FIG. 1 schematically illustrates a construction product 100 including granules 102 disposed over a substrate 104. In an embodiment, the substrate 104 may include a bituminous material. In another embodiment, the construction product may include any suitable roofing materials, such as asphalt shingles, roofing membranes, or the like, or any combinations thereof. An example of a roof according to the disclosure is shown in schematic perspective view in FIG. 2. Roof 200 may include a roof deck 201 and a roofing product, as illustrated, shingles 210 disposed thereon. Shingles 210 may comprise a substrate coated with the granules of embodiments herein. In an embodiment, the granules 102 of the present disclosure may be disposed over at least a portion of an exterior surface of the construction product 100.

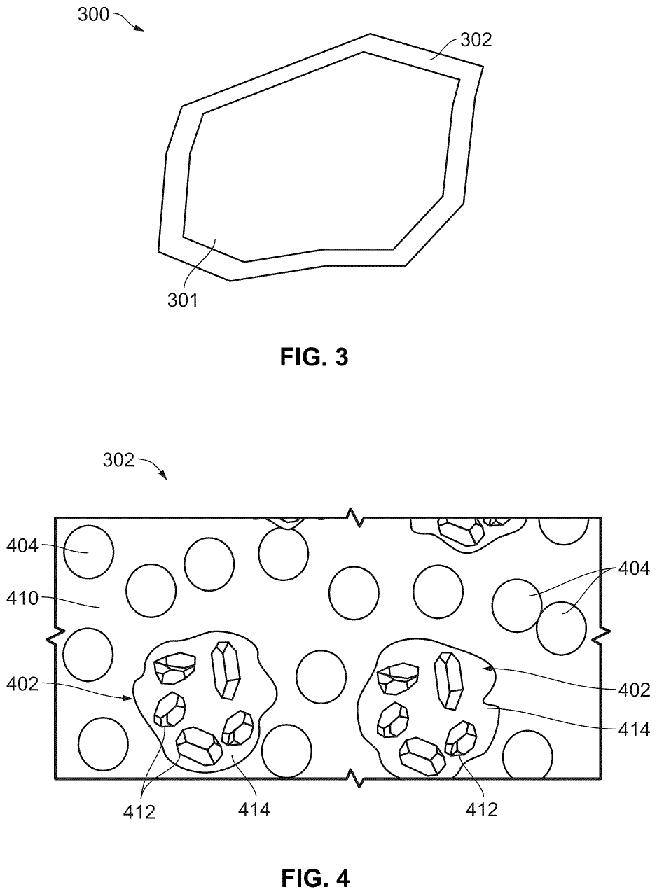

FIG. 3 shows a schematic cross-sectional view of a granule according to an embodiment. The granule 300 may include a core 301 and a coating 302 disposed over the core 301. The coating 302 may overlie at least a portion of a surface of the core. In the illustrated example, the coating 302 may overlie the entire surface of the core 301. In another example, the coating 302 may overlie a portion of the surface of the core 301 or most of the core 301, such as more than 50%, at least 80%, at least 90%, or at least 95% of the surface area of the core. In a particular embodiment, the coating 302 may be conformal to the shape of the core.

It is to be appreciated that the granule 300 described in embodiments herein may be representative of a group of granules, such as a batch of granules, including at least 100 g of granules, such as at least 500 g, or at least 1 kg, or at least 2 kg, or at least 10 kg, or at least 50 kg, or at least 100 kg, or at least 1000 kg, or at least 5000 kg, or at least 8000 kg, or at least 40000 kg of granules.

In an embodiment, the coating 302 may have a particular thickness that may facilitate improved formation and/or properties and/or performance of the granule. In an example, the coating 302 may have a thickness of at least 20 microns, such as at least 30 microns, or at least 50 microns, or at least 70 microns, or at least 90 microns, or at least 115 microns, or at least 130 microns. In another example, the coating may have a thickness of at most 200 microns, or at most 185 microns, or at most 160 microns, or at most 145 microns, or at most 120 microns. Moreover, the coating may have a thickness in a range including any of the minimum and maximum values noted herein. For example, the coating may have a thickness in a range of 20 to 200 microns. As used herein, the coating thickness may be measured according to using cross-sectional optical image analysis or cross-sectional scanning electron microscope image analysis of a statistically significant amount of granules that can be representative of a batch.

In an embodiment, the coating 302 may have improved thickness variation that may facilitate improved formation and/or properties and/or performance of the granule. In an example, the coating 302 may have minimized thickness variation. In another example, the thickness variation across the granule may be 5-10 um. In another example, the thickness variation may be within ±50% of the coating thickness, within ±35%, within ±25%, within ±20%, within ±15%, or within ±10% of the coating thickness. Coating thickness variation may be evaluated using cross-sectional optical image analysis or cross-sectional scanning electron microscope image analysis of a statistically significant amount of granules that can be representative of a batch.

In an embodiment, the core 301 of the granule 300 may be unagglomerated. In a particular example, the core 301 may include a single core particle. In a further embodiment, the granule 300 may be devoid of agglomerated core particles. In another embodiment, a batch of granules may include a certain amount of granules that may have agglomerated core particles. For example, less than 10% of the batch of granules or less than 5% of the batch of granules may include agglomerated core particles. In certain instances, the granule may include agglomerated fine core particles. After reading this disclosure, a skilled artisan appreciates that agglomerated core particles can be coated using the method and coating composition described in embodiments herein.

A wide variety of materials may be used as the core 301 of the granule 300. For example, the core 301 may include crushed slate, crushed igneous rocks, such as rhyolite, nepheline syenite, basalt, andesite, dacite, a slate granule, a shale granule, a mica granule, or metal flakes. In another example, the core 301 may be a synthetic particle, e.g., formed of a ceramic material using conventional methods. In another example, the core 301 may be a naturally occurring mineral.

In an embodiment, the coating 302 may include composite particles dispersed in a first binder. In an embodiment, the first binder may include a first oxide-containing binder. In an embodiment, the first oxide-containing binder may include one or more of silicates, borates, silica, zirconates, titanates, phosphate compounds, or a combination thereof. In another embodiment, the first oxide-containing binder may include one or more silicates. In an example, the silicates may include an alkali metal silicate, ammonium silicate, or any combination thereof. In a particular example, the alkali metal silicate may include lithium silicate, sodium silicate, potassium silicate, or any combinations thereof. In another example, the silicate may include aluminosilicate, alkaline silicate, or any combination thereof.

In an embodiment, the coating 302 may include composite particles, wherein a composite particle may include a plurality of particles contained in a second binder. Turning to FIG. 4, a portion of the coating 302 is illustrated, including composite particles 402 dispersed in a first binder 410. The composite particles 402 may include a plurality of particles 412 contained in a second binder 414. In an embodiment, the particles 412 may include titanium-containing particles. In a particular embodiment, the particles 412 may include titanium dioxide-containing particles. As used herein the term “titanium dioxide” is used interchangeably with “titanium oxide”.

In an embodiment, the composite particles 402 may include an amorphous phase including the second binder 414. The particles 412 may be held by the amorphous phase. In a particular example, the amorphous phase may consist essentially of the second binder. In still another embodiment, the second binder 414 may include a particulate material. In yet another embodiment, the second binder 414 may include nanoparticles

In an embodiment, the second binder 414 may include an oxygen-containing composition. The second binder 414 may include a same or a different ingredient compared to the first binder 410. In another embodiment, the second binder 414 may include a second oxygen-containing binder. In a particular example, the second oxygen-containing binder may include a different composition from the first oxide-containing binder. In another embodiment, the composite particles may include titanium dioxide and at least one oxygen-containing composition different from the composition of the first oxide-containing binder. In a particular embodiment, the composite particles 402 may include an oxygen-containing composition different than the composition of the first oxide-containing binder.

In an embodiment, the second binder 414 may comprise naturally occurring phosphates, aluminosilicates, naturally occurring or synthetic silicon dioxide and silicon oxides. In another embodiment, the binder 414 in the composite particles 402 can be precipitated calcium carbonate, vaterite crystalline form, calcite, aragonite, or a combination thereof. In yet another embodiment, the titanium-containing particle 412 includes titanium dioxide and the composite particles are formed by in-situ precipitation of a mixture of titanium dioxide and alkaline earth metal carbonate or phosphate from a suspension. In an embodiment, the composite particle 402 may include titanium dioxide pigment particles surface-treated with alumina or silica. In yet another embodiment, the coating 302 may include composite particles comprising barium sulfate, kaolin, aluminum hydroxide, silicon dioxide, or a combination thereof in addition to the composite particles 402 comprising titanium-containing particles contained in an oxygen-containing binder. In some embodiment, the composite particles 402 comprising titanium-containing particles may further include barium sulfate, kaolin, aluminum hydroxide, silicon dioxide, or a combination thereof.

In an embodiment, the second binder 414 may include an oxygen-containing composition including an alkaline earth metal element. A particular example of alkaline earth metal element may include calcium, magnesium, or a combination thereof. In a particular embodiment, the second oxygen-containing binder may include an alkaline earth metal element and a non-metal element in addition to oxygen. For example, the second oxygen-containing binder may include a carbonate, a phosphate, or any combination thereof. In a particular example, the second oxygen-containing binder may include one or more of MgCO₃, Mg₃(PO₃)₂, Ca₃(PO₃)₂, and CaCO₃.

In another embodiment, the first binder 410 may include a lower content of an alkaline metal element than the composite particles 402. For example, the composite particles 402 may include a higher content of Mg, a higher content of Ca, or a higher total content of Mg and Ca than the first binder 410. In a particular example, the first binder 410 may be essentially free of Mg, Ca, or both. In another embodiment, the first binder 410 may be essentially free of a carbonate, a phosphate, or both. The presence, absence, and concentration of an element may be determined by using Energy Dispersive Spectroscopy analysis.

In a particular example, the coating 302 may include composite particles 402 including titanium dioxide particles contained in a composition including an alkaline earth carbonate, an alkaline earth phosphate, or any combinations thereof. In a more particular example, the particles 412 may consist essentially of titanium dioxide particles. In an embodiment, the second binder 414 may form a shell at least partially encompassing one or several of the particles 412. In another embodiment, the second binder 414 may be disposed over at least a portion of the surface of each of the particles 412. In yet another embodiment, the shells of adjacent particles 412 maybe bonded/fused/attached together to thereby form the composite particle 412. In an embodiment, the composite particle 412 may be substantially non-spherical in shape. In an embodiment, the composite particle 412 may be substantially spherical in shape. In an embodiment, the particles 412 are crystalline. In another embodiment, the second binder 414 may include one or more of crystalline alkaline earth carbonate and/or crystalline alkaline earth phosphate. In an embodiment, the second binder 414 may be in the form of a substantially continuous coating. In another embodiment, the second binder 414 may include a plurality of crystalline alkaline earth carbonate particles and/or crystalline alkaline earth phosphate particles. In an embodiment, the crystalline calcium carbonate particles are calcite crystals or aragonite crystals.

In an embodiment, the composite particles 402 may include titanium oxide-containing particles including a particular scattering distance between one another that may facilitate improved properties and/or performance of the granule. In an example, the scattering distance may be at least 150 nm, at least 180 nm, at least 230 nm, at least 280 nm, or at least 310 nm. In another example, the titanium dioxide-containing particles may have the scattering distance of at most 350 nm, at most 320 nm, at most 290 nm, or at most 250 nm. Moreover, the scattering distance between the titanium dioxide-containing particles contained in the composite particles 402 may be in a range including any of the minimum and maximum values noted herein.

In an embodiment, the composite particles 402 may include a particular average particle size that may facilitate improved formation and/or properties and/or performance of the granule. In an example, the composite particles 402 may include an average particle size of at least 0.5 microns, such as at least 0.8 microns, at least 1 micron, at least 1.5 microns, at least 2 microns, or at least 2.5 microns. In another example, the composite particles 402 may include an average particle size of at most 5 microns, such as at most 4 microns, at most 3.5 microns, or at most 3 microns. Moreover, the composite particles may include an average particle size in a range including any of the minimum and maximum values noted herein. For instance, the composite particles may include an average particle size in a range of at least 0.5 microns and at most 5 microns or in a range of at least 0.8 microns and at most 3 microns.

In an embodiment, the coating 302 may include a particular content of the composite particles that may facilitate improved formation and/or properties and/or performance of the granule. In an example, the coating 302 may include at least 0.5 wt % of the composite particles for the total weight of the coating 302, such as at least 1.0 wt %, at least 2.5 wt %, at least 4.0 wt %, at least 6.5 wt %, at least 8.0 wt %, at least 9.4 wt %, at least 11.2 wt %, at least 12.0 wt %, at least 12.8 wt %, at least 16.4 wt %, at least 19.2 wt %, at least 22.0 wt %, at least 25.4 wt %, at least 26.7 wt %, or at least 28.8 wt %, at least 32.0 wt %, at least 35 wt %, at least 38 wt %, at least 40 wt %, or at least 45 wt % of the composite particles for the total weight of the coating 302. In another example, the content of the composite particles may be at most 75 wt % for the total weight of the coating 302, such as at most 70 wt %, at most 65 wt % at most 60 wt %, at most 55 wt %, at most 50 wt %, 45 wt %, at most 40 wt %, at most 35 wt %, at most 30.5 wt %, at most 27.5 wt % at most 25.5 wt %, at most 23.5 wt %, at most 21.5 wt %, at most 19.5 wt %, at most 17.5 wt %, at most 15.0 wt %, or at most 13.0 wt % for the total weight of the coating 302. Moreover, the content of the composite particles may be in a range including any of the minimum and maximum values noted herein.

In an embodiment, the coating 302 may include a particular content of titanium dioxide contained in composite particles that may facilitate improved formation and/or properties and/or performance of the granule. In an example, the coating may include titanium dioxide contained in the composite particles of at least 0.1 wt % for the total weight of the coating 302, such as at least 0.5 wt %, at least 0.8 wt %, at least 1.1 wt %, at least 1.5 wt %, at least 1.8 wt %, at least 2.1 wt %, at least 2.6 wt %, at least 2.9 wt %, at least 3.1 wt %, at least 3.3 wt %, at least 4.5 wt %, at least 6.5 wt %, at least 8.5 wt %, at least 10.5 wt %, at least 15.0 wt %, at least 18.0 wt %, or at least 22.5 wt % for the total weight of the coating 302. In another example, the content of titanium dioxide contained in the composite particles in the coating may be at most 50.0 wt % for the total weight of the coating 302, such as at most 45.0 wt %, at most 40.0 wt %, at most 35.0 wt %, at most 25.0 wt %, at most 21.0 wt %, at most 17.5 wt %, at most 15.0 wt %, at most 12.0 wt %, at most 9.5 wt %, at most 7.2 wt %, at most 5.6 wt %, at most 4.2 wt %, at most 3.2 wt %, at most 2.9 wt %, at most 2.6 wt %, at most 2.2 wt %, at most 1.9 wt %, at most 1.6 wt %, at most 1.3 wt %, at most 1.1 wt %, at most 0.9 wt %, or at most 0.7 wt % based on the total weight of the coating 302. Moreover, the content of titanium dioxide contained in the composite particles in the coating may be in a range including any of the minimum and maximum values noted herein. For example, the coating may include an amount of titanium dioxide contained in composite particles in a range of at least 0.1 wt % and at most 50 wt % or in a range of at least 0.1 wt % and at most 25 wt % or in a range of at least 1 wt % and at most 10 wt % for a total weight of the coating or in a range of at least 1.5 wt % to 8 wt % or in a range of 2 wt % to 6 wt % for a total weight of the coating.

In an embodiment, the composite particles 402 may include a particular amount of titanium dioxide that may facilitate improved formation and/or properties and/or performance of the granule. In an example, titanium dioxide contained in the composite particles 402 may be at least 20 wt % based on the total weight of the composite particles 402, such as at least 15 wt %, at least 20 wt %, at least 25 wt %, at least 30 wt %, at least 35 wt %, at least 40 wt %, at least 45 wt %, at least 50 wt %, at least 55 wt %, at least 60 wt %, at least 65 wt %, at least 70 wt %, or at least 75 wt % based on the total weight of the composite particles 402. In another example, the amount of titanium dioxide contained in the composite particles may be at most 90 wt % based on the total weight of the composite particles 402, such as at most 85 wt %, at most 80 wt %, at most 75 wt %, at most 70 wt %, at most 65 wt %, at most 60 wt %, at most 55 wt %, at most 50 wt %, or at most 45 wt % based on the total weight of the composite particles 402. Moreover, the amount of titanium dioxide contained in the composite particles 402 may be in a range including any of the minimum and maximum percentages noted herein.

In an embodiment, the granule 300 (illustrated in FIG. 3) may include a particular total amount of titanium dioxide that may facilitate improved formation and/or properties and/or performance of the granule. In an example, the total amount of titanium dioxide may be at least 0.05 wt. % based on the total weight of the coating 302, such as at least 0.1 wt %, at least 0.2 wt %, at least 0.5 wt %, at least 1 wt %, at least 2 wt. %, at least 3 wt. %, at least 4 wt. %, at least 5 wt %, at least 8 wt %, at least 15 wt %, at least 19 wt %, at least 22 wt %, at least 24 wt %, or at least 26 wt % based on the total weight of the coating 302. In another example, the total amount of titanium dioxide may be at most 30 wt. % for the total weight of the coating 302, such as at most 75 wt. %, at most 70 wt. %, at most 65 wt. %, at most 60 wt. %, at most 54 wt. %, at most 50 wt. %, at most 46 wt. %, at most 41 wt. %, at most 37 wt. %, at most 32 wt. %, at most 28 wt. %, at most 25 wt. %, at most 21 wt. %, at most 17 wt. %, at most 12 wt. %, at most 7 wt. %, or at most 4 wt. % based on the total weight of the coating 302. Moreover, the total amount of titanium dioxide may be in a range including any of the minimum and maximum percentages noted herein. For example, the total content of titanium dioxide may be from 0.05 wt. % to 30 wt. % based on the total weight of the coating 302.

In an embodiment, the content of individual particles made of titanium oxide may be at least 0.01 wt % of the total content of titanium oxide in the coating, such as greater than 1 wt. % at least 5 wt. %, at least 8 wt. %, at least 12 wt. %, at least 18 wt. %, at least 25 wt. %, at least 30 wt. %, at least 35 wt. %, at least 41 wt. %, at least 47 wt. %, at least 52 wt. %, at least 58 wt. %, at least 62 wt. %, at least 66 wt. %, or at least 70 wt. % of the total content of titanium oxide in the coating. Alternatively or additionally, the content of individual particles made of titanium oxide may be less than 100 wt. % of the total content of titanium oxide in the coating, such as at most or less than 99 wt. %, at most 95 wt. %, at most 90 wt. %, at most 85 wt. %, at most 82 wt. %, at most 78 wt. %, at most 75 wt. %, at most 71 wt. %, at most 68 wt. %, at most 63 wt. %, at most 57 wt. %, at most 52 wt. %, at most 50 wt. %, at most 46 wt. %, or at most 42 wt. % of the total content of titanium oxide in the coating. Moreover, the content of individual particles made of titanium oxide may be in a range including any of the minimum and maximum percentages noted herein.

In an embodiment, the amount of titanium oxide contained in the composite particles may be at least 1 wt. % of the total content of titanium oxide in the coating, such as at least 5 wt. %, at least 15 wt. %, at least 23 wt. %, at least 29 wt. %, at least 35 wt. %, at least 44 wt. %, at least 52 wt. %, at least 58 wt. %, at least 62 wt. %, at least 66 wt. %, at least 70 wt. %, at least 75 wt. %, at least 80 wt. %, or at least 86 wt. % based on the total content of titanium oxide in the coating. Alternatively or additionally, the content of titanium oxide contained in composite particles may be less than 100 wt. % of the total content of titanium oxide in the coating, such as at most or less than 99 wt. %, at most 95 wt. %, at most 91 wt. %, at most 88 wt. %, at most 82 wt. %, at most 76 wt. %, at most 70 wt. %, at most 65 wt. %, at most 60 wt. %, at most 55 wt. %, at most 50 wt. %, at most 47 wt. %, at most 42 wt. %, or at most 36 wt. % based on the total content of titanium oxide in the coating. Moreover, the content of titanium oxide contained in composite particles may be in a range including any of the minimum and maximum percentages noted herein.

In an embodiment, the granule 300 (illustrated in FIG. 3) may include a particular ratio, Rt/sc, of the thickness of the coating 302 (illustrated in FIG. 3) to an average particle size of the composite particles 402 (illustrated in FIG. 4) that may facilitate improved formation and/or properties and/or performance of the granule. In an example, the ratio, Rt/sc, may be at least 4:1, at least 7:1, at least 10:1, at least 20:1, at least 30:1, at least 40:1, at least 70:1, at least 90:1, or at least 110:1. In another example, the ratio, Rt/sc, may be at most 400:1, at most 350:1, at most 300:1, at most 200:1, at most 160:1, or at most 130:1. Moreover, the ratio, Rt/sc, may be in a range including any of the minimum and maximum values noted herein. For instance, the ratio, Rt/sc, may be in a range of at least 4:1 and at most 400:1 or in a range of at least 20:1 and at most 200:1.

Referring to FIG. 4, the coating 302 may include individual particles 404 contained in the first binder 410. In an embodiment, at least some, a majority (i.e., more than 50% of the individual particles), or essentially all of the individual particles may be spaced apart from one another. In an embodiment, the individual particles 404 may include un-agglomerated single particles. In another embodiment, the individual particles 404 may include a small cluster of particles having the same chemical composition.

In an embodiment, the individual particles 404 may include a pigment. For example, the individual particles 404 may include titanium dioxide, barium sulphate, or a combination thereof. In a particular embodiment, the coating 302 may include a uniform dispersion of the composite particles 402 and the individual particles made of titanium dioxide.

In an embodiment, the coating 302 may include individual particles 404 that may have a scattered distribution pattern. For example, the individual particles 404 may include an average distance between one another that may facilitate properties and/or performance of the granule. In an embodiment, an average distance between the individual particles 404 may be at least 150 nm, such as at least 180 nm, at least 210 nm, at least 240 nm, at least 270 nm, at least 310 nm, or at least 330 nm. Alternatively or additionally, the average distance between the individual particles 404 may be at most 350 nm, such as at most 320 nm, at most 305 nm, at most 260 nm, at most 230 nm, at most 190 nm, or at most 175 nm. Moreover, the average distance between the individual particles 404 may be in a range including any of the minimum and maximum values noted herein, such as in a range of at least 150 nm to 350 nm or in a range of at least 180 nm to 330 nm or in a range of at least 230 nm to 290 nm. In a particular embodiment, the individual particles may include particles made of titanium dioxide having a scattered distribution pattern. For instance, individual particles made of titanium dioxide may have an average distance including any of the values noted herein. In another example, individual particles made of titanium dioxide may have an average distance between one another in a range including any of the minimum and maximum values noted herein, such as in a range of at least 150 nm to 350 nm or in a range of at least 180 nm to 330 nm or in a range of at least 230 nm to 290 nm.

In an embodiment, the individual particles 404 may include a particular first average particle size that may facilitate improved formation and/or properties and/or performance of the granule. In an example, the first average particle size may be at least 0.2 um, such as at least 0.4 um, at least 0.6 um, at least 0.8 um, at least 1.1 um, or at least 1.3 um. In another example, the first average particle size may be at most 1.5 um, at most 1.2 um, at most 0.9 um, or at most 0.7 um. Moreover, the first average particle size may be in a range including any of the minimum and maximum values noted herein. For example, the first average particle size may be in a range including at least 0.2 um and at most 1.5 um.

In an embodiment, the composite particles 402 may include titanium oxide-containing particles including a particular second average particle size that facilitate improved formation and/or properties and/or performance of the granule. In an example, the second average particle size may be at least 20 nm, at least 30 nm, at least 50 nm, at least 80 nm, at least 100 nm, at least 150 nm, at least 180 nm, at least 230 nm, at least 250 nm, at least 300 nm, at least 340 nm, or at least 380 nm. In another example, the second average particle size may be at most 400 nm, such as at most 360 nm, at most 330 nm, at most 290 nm, at most 240 nm, at most 200 nm, at most 160 nm, at most 120 nm, or at most 70 nm. Moreover, the second average particle size may be in a range including any of the minimum and maximum values noted herein. For example, the second average particle size may be in a range including at least 20 nm and at most 400 nm. In a particular embodiment, the titanium oxide-containing particles contained in the composite particles may be spaced apart from one another.

In an embodiment, the coating 302 may include a particular ratio of the first average particle size to the second average particle size that may facilitate improved formation and/or properties and/or performance of the granule. In an example, the ratio of the first average particle size to the second average particle size may be at least 0.5:1, at least 1.5:1, at least at least 3:1, at least 5:1, at least 7:1, at least 10:1, at least 14:1, at least 17:1, at least 21:1, at least 25:1, at least 29:1, at least 33:1, at least 37:1, at least 40:1, at least 44:1, at least 47:1, at least 51:1, at least 55:1, at least 59:1, or at least 63:1. In another example, the ratio of the first average particle size to the second average particle size may be at most 75:1, at most 73:1, at most 70:1, at most 66:1, at most 62:1, at most 58:1, at most 53:1, at most 48:1, at most 42:1, at most 39:1, at most 34:1, at most 27:1, at most 23:1, at most 19:1, at most 16:1, at most 12:1, at most 9:1, at most 6:1, or at most 3:1. Moreover, the ratio of the first average particle size to the second average particle size may be in a range including any of the minimum and maximum values noted herein. For example, the ratio of the first average particle size to the second average particle size may be at least 0.5:1 and at most 75:1.

In an embodiment, the coating 302 may include a particular content of individual particles made of titanium dioxide that may facilitate improved formation and/or properties and/or performance of the granule. In an example, the amount of individual particles made of titanium dioxide may be at least 0.01 wt % based on a total weight of the coating, at least 0.03 wt %, at least 0.05 wt %, at least 0.1 wt %, at least 0.5 wt %, at least 1.0 wt %, at least 1.5 wt %, at least 2.5 wt %, at least 3.0 wt %, at least 4.5 wt %, at least 6.5 wt %, or at least 8.5 wt %, at least 10.5 wt %, at least 15.0 wt %, at least 18.0 wt %, at least 22.5 wt %, at least 25.0 wt %, at least 30.0 wt %, at least 35.0 wt %, at least 41.0 wt %, at least 46.0 wt %, or at least 50.0 wt % based on the total weight of the coating 302. In another example, the amount of the individual particles made of titanium dioxide may be at most 75 wt. % for the total weight of the coating 302, at most 70 wt. %, at most 65 wt. %, at most 60 wt. %, at most 54 wt. %, at most 50 wt. %, at most 46 wt. %, at most 41 wt. %, at most 37 wt. %, at most 32 wt. %, at most 28 wt. %, at most 25 wt. %, at most 21.0 wt %, at most 17.5 wt %, at most 15.0 wt %, at most 12.0 wt %, at most 9.5 wt %, at most 7.2 wt %, at most 5.6 wt %, at most 4.2 wt %, at most 3.0 wt %, at most 2.4 wt %, at most 2.1 wt %, at most 1.8 wt %, at most 1.5 wt %, or at most 1.1 wt %, at most 0.6 wt %, at most 0.3 wt %, or at most 0.1 wt % based on the total weight of the coating 302. Moreover, the content of individual particles made of titanium dioxide may be in a range including any of the minimum and maximum percentages noted herein. In certain instances, the coating 302 may be essentially free of individual particles made of titanium dioxide.

In an embodiment, the coating 302 may include a particular content ratio, Ccp/Cip, that may facilitate improved formation and/or properties and/or performance of the granule, wherein Ccp may be the content of the composite particles 402 for a total weight of the coating 302, and Cip may be an amount of the individual particles made of titanium oxide for a total weight of the coating 302. In an example, the content ratio, Ccp/Cip, may be at least 0.02:1, such as at least 0.06:1, at least 0.1:1, at least 0.2:1, at least 0.4:1, at least 1:1, at least 2:1, at least 3:1, at least 5:1, at least 7:1, at least 9:1, at least 10:1, at least 14:1, at least 17:1, at least 19:1, at least 23:1, at least 26:1, at least 29:1, at least 34:1, at least 35:1, at least 55:1, at least 70:1, at least 90:1, at least 130:1, at least 250:1, at least 350:1, at least 450:1, or at least 550:1. In another example, the content ratio, Ccp/Cip, may be at most 600:1, at most 500:1, at most 400:1, at most 300:1, at most 200:1, at most 100:1, at most 70:1, at most 50:1, at most 35:1, at most 25:1, at most 15:1, at most 11:1, at most 8:1, at most 6:1, at most 4:1, at most 3:1, at most 2:1, at most 1:1, at most 0.5:1, or at most 0.1:1. Moreover, the content ratio, Ccp/Cip, may be in a range including any of the minimum and maximum percentages noted herein.

In an embodiment, the coating 302 may include a particular content ratio, Cip/Ctocp, that may facilitate improved formation and/or properties and/or performance of the granule, wherein Ctocp may be the content of the titanium oxide contained in the composite particles for the total weight of the coating 302, and Cip may be the content of the individual particles made of titanium oxide for the total weight of the coating 302. The titanium oxide contained in the composite particles may be also referred to bound titanium oxide in this disclosure. In an example, the content ratio, Cip/Ctocp, may be greater than 0, such as at least 0.01:1, at least 0.1:1, at least 0.14:1, at least 0.5:1, at least 0.7:1, at least 1.0:1, at least 1.5:1, at least 1.8:1, at least 2.0:1, at least 2.4:1, at least 3.0:1, at least 6:1, at least 10:1, at least 15:1, at least 25:1, at least 45:1, at least 65:1, at least 90:1, at least 115:1, at least 150:1, or at least 225:1. In another example, the content ratio, Cip/Ctocp, may be at most 250:1, at most 210:1, at most 170:1, at most 145:1, at most 125:1, at most 85:1, at most 50:1, at most 30:1, at most 20:1, at most 17:1, at most 12:1, at most 10:1, at most 9:1, at most 7:1, at most 5.5:1, at most 3.5:1, at most 3.2:1, at most 2.8:1, at most 2.6:1, at most 2.4:1, at most 2.1:1, at most 1.8:1, at most 1.5:1, at most 1.1:1, at most 0.8:1, at most 0.7:1, at most 0.6:1, at most 0.2, or at most 0.1:1. Moreover, the content ratio, Cip/Ctocp, may be in a range including any of the minimum and maximum percentages noted herein. For example, the content ratio, Ccp/Cip, may be in a range including at least 0.02:1 and at most 600:1 or in a range including at least 0.1:1 and at most 11:1 or in a range including at least 0.14:1 and at most 2.4:1.

In an embodiment, the granule 300 (illustrated in FIG. 3) may have a solar reflectivity of at least 20%, at least 26%, at least 33%, at least 36%, at least 39%, at least 43%, at least 46%, at least 51%, at least 55%, at least 60%, at least 65%, at least 70%, at least 75%, at least 80%, or at least 85%. Alternatively or additionally, the granule 300 may have a solar reflectivity of at most 90%, such as at most 85%, at most 82%, at most 78%, at most 73%, at most 68%, or at most 63%. Moreover, the solar reflectivity of the granule may be in a range including any of the minimum and maximum percentages noted herein. After reading this disclosure, a skilled artisan appreciates certain other factors may affect solar reflectivity of the granule, such as the type and/or amount of pigments, color and/or shade of the granule, or any combination thereof. It is worth noting the granule of embodiments herein may have improved solar reflectivity compared to a conventional granule having the same color and/or shade

In another embodiment, the granule 300 (illustrated in FIG. 3) may have an L* value in the CIELAB system of at least 25, such as at least 30, at least 40, at least 45, at least 50, at least 55, at least 60, at least 65, at least 70, at least 80, or at least 90. In still another embodiment, the granule 300 may have an L* value of at most 95, at most 92, at most 85, at most 75, at most 70, at most 62, at most 53, at most 47, at most 42, at most 35, or at most 30. Moreover, the granule 300 may have an L* value in a range including any of the minimum and maximum values noted herein. For example, the granule 300 may have an L* value of at least 25 and at most 95. In a particular embodiment, the granule 300 may have an L* value of greater than 60 and at most 95 in the CIELAB system. A skilled artisan appreciates that solar reflectivity may be affected by L* values. It is worth noting that the granule of embodiments herein may have improved solar reflectivity compared to a conventional granule having a similar L* value.

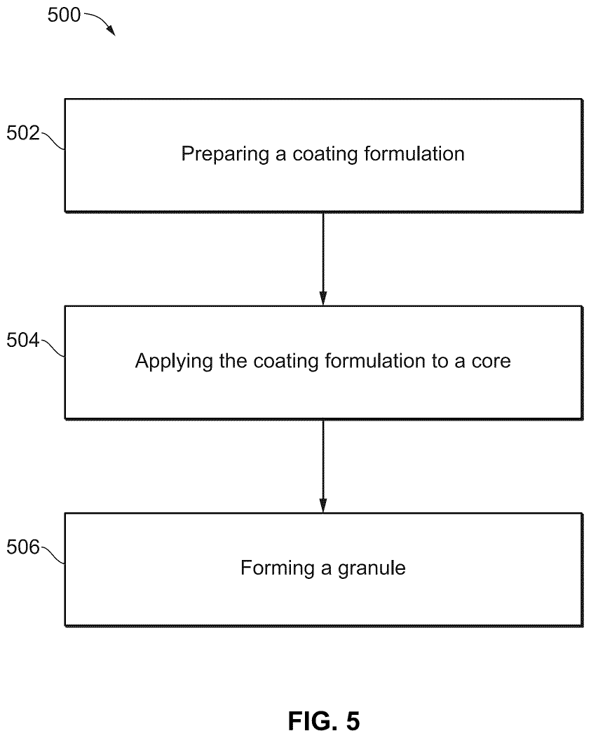

FIG. 5 includes a flowchart illustrating a process for forming the granule of embodiments herein. The process 500 may include preparing a coating composition at block 502.

Preparing a coating composition may include forming a mixture including the composite particles, the first binder, and one or more of fillers, pigments, and colorants. As discussed in embodiments herein, the first binder may include one or more silicates, such as an alkali metal silicate. In an example, one or more silicate may be provided as a solution, such as aqueous alkali metal silicate and/or aqueous ammonium silicate. In a particular example, the mixture may include sodium silicate.

In an embodiment, the coating composition may include one or more pigments and/or colorants. Examples of pigments may include solar-reflective pigment. In a particular embodiment, the coating may include individual solar reflective pigment particles. For example, solar-reflective pigment may include bright white pigment, such as barium sulfate, titanium dioxide, or the like, or any combination thereof. In a particular example, individual solar-reflective pigment particles may include individual titanium dioxide particles, individual barium sulfate particles, or any combination thereof. After reading this disclosure, a skilled artisan appreciates any contents or ratios associated with individual titanium dioxide particles may be applied to individual solar reflective pigment particles. As used herein, individual titanium dioxide particles may be also referred to as individual particles made of titanium dioxide. Another example of solar-reflective pigment may include colored solar-reflective pigments.

Conventional solar-reflective pigments may be used, such as near infrared-reflective pigments available from the Shepherd Color Company, Cincinnati, Ohio, including Arctic Black 10C909 (chromium green-black), Black 411 (chromium iron oxide), Brown 12 (zinc iron chromite), Brown 8 (iron titanium brown spinel), and Yellow 193 (chrome antimony titanium), as well as near infrared reflective pigments available from the Ferro Corporation (Cincinnati, Ohio), such as Brown 10364, Eclipse Black 10201, IR BRN Black V-780, Forest Green 10241, Blue V-9248, Bright Blue V-9250, Turquoise F05686, Eclipse Black 10202, Eclipse Black 10203, Red V-13810, IR Cobalt Green V-12600, H IR Green V-12650, IR Brown Black V-778, and Brown Black V-799.

An example of dark colored, solar-reflective pigment may include a solid solution including iron oxide, such as disclosed in U.S. Pat. No. 6,174,360, incorporated herein by reference. A colored solar-reflective pigment may also include a near infrared-reflecting composite pigment such as disclosed in U.S. Pat. No. 6,521,038, incorporated herein by reference. Another example of pigments may include composite pigments composed of a near-infrared non-absorbing colorant of a chromatic or black color and a white pigment coated with the near infrared-absorbing colorant.

In an exemplary implementation, the coating composition may include 1 wt. % to 60 wt. % of at least one solar-reflective pigment based on the total weight of the coating composition, 5 wt. % to 25 wt. %, or 7 wt. % to 15 wt. % based on the total weight of the coating composition.

The coating composition may optionally include at least one solar-reflective functional pigment. Examples of solar-reflective functional pigments include light-interference platelet pigments, mirrorized silica pigments, metal flake pigments, metal oxide coated flake pigments, and alumina. Further examples of light-interference platelet pigments may include pigments that may provide suitable colors, such as golden color, wine red color, red brown color, bronze color, interference green color, interference blue color, interference violet color, silver white color, interference red color, interference golden color, silver white color, bronze appearance, gold appearance, off-white appearance, off-white/gold appearance, off-white/green appearance, off-white/blue appearance, bronze appearance, or other color and/or appearance as desired by applications. Additional examples of pigments may include one or more of materials including mica, rutile titanium dioxide, iron oxide, rutile titanium dioxide, anatase titanium dioxide, and tin oxide.

Further examples of light-interference platelet pigments may also include pigments based on mica covered with a thin layer of titanium dioxide and/or iron oxide; pigment based upon aluminum oxide platelets coated with metal oxides, pigments based on SiO₂ platelets coated with metal oxides, ultra interference pigments based on titanium dioxide and mica, or the like, mirrorized silica pigments, or any combination thereof.

Aluminum oxide, preferably in powdered form, can be used as solar-reflective additive in the color coating formulation to improve the solar reflectance of colored roofing granules without affecting the color. The aluminum oxide should have particle size less than U.S. #40 mesh (425 micrometer), preferably between 0.1 micrometer and 5 micrometer. More preferably, the particle size is between 0.3 micrometer and 2 micrometer. The alumina should have percentage aluminum oxide >90%, more preferably >95%.

Examples of metal flake pigments include aluminum flake pigments, iron flake pigments, iron-aluminum alloy flake pigments, copper flake pigments, brass flake pigments, titanium flake pigments, iron-cobalt-aluminum alloy flake pigments, stainless steel flake pigments, chromium flake pigments, nickel flake pigments, and nickel alloy flake pigments. Examples of metal oxide coated flake pigments may include those disclosed in U.S. Pat. No. 6,589,331, which is incorporated herein by reference. Additional examples of pigments may include conventional coatings pigments.

In an embodiment, the coating composition may include fillers. Exemplary fillers may include aluminosilicate or clay, such as kaolin and/or derivates thereof, calcined clay (metakaolin), dickite or nacrite, calcium carbonate, pigment spacer, pigment dispersants, coating viscosity modifiers, coating additives, talc, silicon dioxide or silica, colloidal silica, barium sulfate, zinc oxide, nano-particle additives for pigment exfoliation, or any combination thereof. An exemplary kaolin derivative may be formed by weathering, such as kaolinite. A further example of filler may include reflective fillers such as mirrorized silica flakes, metal flakes, or metal oxide coated flakes. In another example, fillers may include one or more one non-clay latent heat reactants. Examples of non-clay latent heat reactant may include fluoride compounds such as aluminum fluoride, gallium fluoride, indium fluoride, sodium fluoride, potassium fluoride, lithium fluoride, sodium silicofluoride, ammonium silicofluoride, potassium silicofluoride, lithium silicofluoride, barium silicofluoride, zinc silicofluoride, and magnesium silicofluoride, as well as fluoride containing minerals such as cryolite. Further examples of non-clay latent heat reactants may include hydraulic cements such as Portland cements, such as Type I Portland cement and Type III Portland cement, blended Portland cements, such as blends of Portland cement with blast furnace slag, blends of Portland cement with pozzolanic materials such as fly ash, expansive Portland cements such as Types K, M, S and O cements, rapid setting and rapid hardening Portland cements such as regulated set cement, very high early strength cement, high iron cement, and ultra-high early strength cement, low-tricalcium aluminate cements such as API class A, C, D, E and F cements, calcium aluminate cements, as well as Portland cement constituents including tricalcium silicate, beta-dicalcium silicate, alite and belite.

In a particular exemplary implementation, the coating composition may include the first binder, the composite particles, individual particles made of titanium dioxide, aluminosilicate, and optionally other colored pigments. The mixture may further include a solvent, such as water.

In an embodiment, the ingredients of the coating composition may be added sequentially to an aqueous binder solution. A mixing device may be utilized to facilitate formation of a homogenous mixture, such as a high shear mixer, a rotary tumbler, or the like. In a particular example, a high-shear disperser with a high-shear impeller may be utilized. In another embodiment, addition of an ingredient may be facilitated by stirring. For example, stirring the mixture may be performed following the addition of an ingredient. In another example, a uniform dispersion may be formed prior to the addition of another ingredient to the mixture. In a particular example, stirring the mixture may be performed continuously until the final homogenous mixture is formed with all the ingredients.

In an embodiment, mixing may be performed at a certain speed to facilitate improved dispersion of ingredients. In an example, mixing may include different mixing speeds and/or time to facilitate uniform dispersion of ingredients. In an exemplary implementation, preparing a coating composition may include preparing an aqueous silicate solution. For example, sodium silicate may be mixed with a small amount of water, such as 10 wt. % of total water that may be used to make the mixture. Mixing of sodium silicate and water may be performed for 10 seconds to a minute with a tip speed of 1.2 to 1.6 m/s. The composite particles may be added to the silicate solution and dispersed homogeneously for 0.5 to 2 minutes at the tip speeds of 4 to 6 m/s. Individual particles made of titanium dioxide may then be added and dispersed homogeneously for another 0.5 to 2 minutes at the tip speeds of 4 to 6 m/s, which may be followed by the addition of fillers, such as kaolin clay or others disclosed in embodiments herein and mixing 0.5 to 2 minutes at the tip speeds of 6 to 8 m/s. Optionally, colored pigments may then be added to the mixture and dispersed homogeneously for 0.5 to 2 minutes at the tip speeds of 6-8 m/s. Multiple pigments may be sequentially added upon uniform color spread in the mixture. After all the solid ingredients are added, the mixture may be dispersed thoroughly at a higher speed, such as the tip speeds of 10 to 14 m/s for 5-10 minutes. Afterwards, the remaining 90 wt. % of water may be added to the dispersed mixture and blended at a lower speed such as the tip speed of 1.2 to 1.6 m/s to form a homogeneous and uniform slurry.

After the coating composition is made, the process 500 may continue to block 504, applying the coating composition to a core.

In an embodiment, the core and a certain amount of the coating composition may be mixed to facilitate improved formation of the granule. In an example, the coating composition may be from 2 wt. % to 20 wt. % of the weight of the core or from 4 wt. % to 10 wt. % of the weight of the core. Alternatively, the core may be spray-coated by the coating composition, such as in a rotary drum or utilizing a fluidized bed coating process to achieve uniform coverage. Other traditional coating methods may be used, such as pan coating, dip coating, or the like, or any combination thereof. After the application of the coating composition, the wet particles may be dried at a low temperature, such as 40° C. to 65° C. In an exemplary implementation, drying may be performed in a rotary drum or fluidized bed drier. The dried particles may then be calcined at a particular temperature that may facilitate formation of the granule having improved property and/or performance. In an example, the calcination temperature may be greater than the dehydration temperature of the coating composition and less than the sintering temperature of the coating composition to form the granule. In an embodiment, the granules may be made in batches. In another embodiment, the granules may be made in a continuous process.

In a particular embodiment, calcination may be performed at a relatively low temperature, such as lower than the decomposition temperature of the second binder or the composite particles to facilitate formation of the granule having improved property and/or performance. In an example, the calcination temperature may be less than 1050° C., such as at most 950° C., at most 825° C., at most 695° C., or at most 570° C. In another example, the calcination temperature may be at least 400° C., at least 450° C., at least 500° C., or at least 550° C. Moreover, the calcination temperature may be in a range including any of the minimum and maximum values noted herein. In a further embodiment, calcination may be performed for a time that may facilitate formation of the granule having improved property and/or performance. In an example, the calcination time may be at most 30 minutes, such as at most 25 minutes, at most 20 minutes, or at most 15 minutes. In another example, the calcination time may be at least 5 minutes, at least 10 minutes, at least 15 minutes, or at least 20 minutes. Moreover, the calcination time may be in a range including any of the minimum and maximum values noted herein.

After calcination, the granule may be allowed to cool down to the room temperature, i.e., 20° C. to 25° C. In an embodiment, calcination may facilitate hardening of the coating that can be weather resistant and have improved durability and/or color fastness. In an embodiment, the finally formed coating may include a ceramic phase. In a particular example, the coating may be ceramic. In another embodiment, the coating may be essentially free of pores.

In another embodiment, a second layer, and a third and further layers, may be applied in the similar manner. In a particular embodiment, the coating composition may form a single layer having, or plural layers collectively having, sufficient thickness to provide good hiding and opacity, such as the thickness discussed in embodiments herein. It is to be appreciated that the color of the granule may be facilitated by pigments and/or colorants in the coating. Accordingly, a skilled artisan appreciates that the granule of embodiments herein may have any colors as desired by applications. For example, for forming roofing materials having mid to deep tone colors, the coating of the granule may include pigments that can allow the colors to be reached. It is worth noting that the granule of embodiments herein may have improved solar reflectance compared to conventional granules having the same color.

In an embodiment, the process 500 may continue to form a roofing product including the granule. For example, the granules having desirable colors may be deposited onto the asphalt shingle surface during the shingle manufacturing to enhance the solar heat reflectance of the final product. For instance, the granules may be directly applied on to hot asphalt coating to form the shingle. In another example, the granules may be adhered to a shingle stock material. Examples of granule deposition apparatus that may be employed to manufacture asphalt shingles according to the present disclosure are provided, for example, in U.S. Pat. Nos. 4,583,486, 5,795,389, and 6,610,147, and U.S. Patent Application Publication U.S. 2002/0092596, all of which are incorporated herein by reference.

The process of the present invention advantageously permits the solar reflectance of the shingles employing the granules to be tailored to achieve specific color effects. The granules of embodiments herein can be employed in the manufacture of solar-reflective roofing products, such as solar-reflective asphalt shingles and roll goods, including bituminous membrane roll goods. The granules can be embedded in the surface of bituminous roofing products using conventional methods.

Bituminous roofing products are typically manufactured in continuous processes in which a continuous substrate sheet of a fibrous material such as a continuous felt sheet or glass fiber mat is immersed in a bath of hot, fluid bituminous coating material so that the bituminous material saturates the substrate sheet and coats at least one side of the substrate. The reverse side of the substrate sheet can be coated with an anti-stick material such as a suitable mineral powder or a fine sand. Roofing granules are then distributed over selected portions of the top of the sheet, and the bituminous material serves as an adhesive to bind the roofing granules to the sheet when the bituminous material has cooled. The sheet can then be cut into conventional shingle sizes and shapes (such as one foot by three feet rectangles), slots can be cut in the shingles to provide a plurality of “tabs” for ease of installation and aesthetic effect, additional bituminous adhesive can be applied in strategic locations and covered with release paper to provide for securing successive courses of shingles during roof installation, and the finished shingles can be packaged. More complex methods of shingle construction can also be employed, such as building up multiple layers of sheet in selected portions of the shingle to provide an enhanced visual appearance, or to simulate other types of roofing products. Alternatively, the sheet can be formed into membranes or roll goods for commercial or industrial roofing applications.

The bituminous material used in manufacturing roofing products may be derived from a petroleum-processing by-product such as pitch, “straight-run” bitumen, or “blown” bitumen. The bituminous material may be modified with extender materials such as oils, petroleum extracts, and/or petroleum residues. The bituminous material can include various modifying ingredients such as polymeric materials, such as SBS (styrene-butadiene-styrene) block copolymers, resins, flame-retardant materials, oils, stabilizing materials, anti-static compounds, and the like. Preferably, the total amount by weight of such modifying ingredients is at most 15 wt. % of the bituminous material. The bituminous material can also include amorphous polyolefins, up to 25 wt. %. Examples of suitable amorphous polyolefins include atactic polypropylene, ethylene-propylene rubber, etc. Preferably, the amorphous polyolefins employed have a softening point of from 130° C. to 160° C. The bituminous composition can also include a suitable filler, such as calcium carbonate, talc, carbon black, stone dust, or fly ash, preferably in an amount from 10 wt. % 70 wt. % of the bituminous composite material.

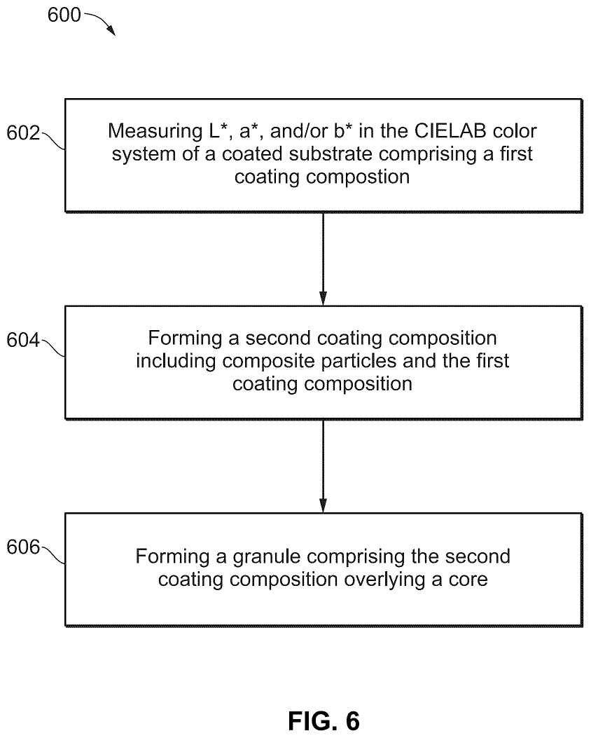

FIG. 6 shows a flowchart illustrating a further process 600 to prepare the granule. The process 600 may facilitate formation of granules having a predetermined color. At block 602, the process may include measuring L*, a*, and/or b* in the CIELAB color system of a coated substrate. The coated substrate may include a first coating. The first coating may include a first coating composition. In an example, the first coating composition may be free of the composite particles. In another example, the first coating composition may include a first content of the composite particles. In an embodiment, the coated substrate may be a first granule including the first coating over a first core.

The first granule may have a first color or a shade. In another embodiment, the process 600 may include measuring L*, a*, and/or b* in the CIELAB color system of the first granule. In a further embodiment, measuring may include measuring at least one of L* or b*. For example, at least L* may be measured. In another example, at least b* may be measured. In still another example, both L* and b* may be measured. In still another example, all of a*, L*, and b* may be measured. As used herein, the measure of the granule color may be made using the Roofing Granules Color Measurement Procedure from the Asphalt Roofing Manufacturers Association (ARMA) Granule Test Procedures Manual, ARMA Form No. 441-REG-96.

In an embodiment, the process 600 may include adapting the content of the composite particles in the first coating based on the value of L*, a*, and/or b* of the first granule. In another embodiment, adapting the content of the composite particles may facilitate desired changes to the color or shade of the first granule. In another embodiment, the change of the amount of the composite particles may be determined by the value of L*, a*, and/or b* of the first granule and the value of L*, a*, and/or b* of a desired color or shade. For example, the process 600 may include providing a database including data related to values of L*, a*, and/or b* of different colors and/or shades and corresponding amounts of composite particles in one or more coating compositions. In another example, information of coating compositions may be referenced to help determine the adaptation of the amount of composition particles of the first coating composition.

In a further embodiment, as illustrated at block 604, the process 600 may include adding a predetermined amount of composite particles to the first coating composition and forming a second coating composition. At block 606, the process 600 may include forming a second granule having the second coating overlying the first core, wherein the second coating may include the second coating composition, and the second granule may have the desired color or shade.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

Embodiment 1. A granule comprising:
a core; and
a coating overlying at least a portion of the core, wherein the coating comprises composite particles contained in an oxide-containing binder, wherein the composite particles comprise titanium-containing particles contained in an oxygen-containing binder including an alkaline earth metal.

Embodiment 2. A granule comprising:
a core; and
a coating overlying at least a portion of the core, wherein the coating comprises a) composite particles contained in an oxide-containing binder, wherein the composite particles comprise titanium dioxide and at least one other oxygen-containing composition, and b) individual particles made of titanium dioxide contained in the oxide-containing binder.

Embodiment 3. The granule of any one of embodiments 1 to 2, wherein the core is unagglomerated.

Embodiment 4. The granule of any one of embodiments 1 to 3, wherein the coating has a thickness of at least 20 microns, at least 30 microns, at least 50 microns, at least 70 microns, at least 90 microns, at least 115 microns, or at least 130 microns; and/or wherein the coating has the thickness of at most 200 microns, at most 185 microns, at most 160 microns, at most 145 microns, or at most 120 microns; and/or wherein the coating has the thickness of 20 to 200 microns.

Embodiment 5. The granule of any one of embodiments 1 to 4, wherein the composite particles comprise an average particle size of at least 0.5 microns and at most 5 microns.

Embodiment 6. The granule of any one of embodiments 1 to 5, comprising a ratio of a thickness of the coating to an average particle size of composite particles, Rt/sc, wherein the ratio, Rt/sc, is at least 4:1, at least 7:1, at least 10:1, at least 20:1, at least 30:1, at least 40:1, at least 70:1, at least 90:1, or at least 110:1; and/or wherein the ratio, Rt/sc, is at most 400:1, at most 350:1, at most 300:1, at most 200:1, at most 160:1, or at most 130:1; and/or wherein the ratio, Rt/sc, is at least 7:1 and at most 400:1 or at least 20:1 and at most 200:1.

Embodiment 7. The granule of any one of embodiments 1 to 6, wherein the coating comprises the composite particles in an amount of at least 0.5 wt % for the total weight of the coating, at least 1.0 wt %, at least 2.5 wt %, at least 4.0 wt %, at least 6.5 wt %, at least 8.0 wt %, at least 9.4 wt %, at least 11.2 wt %, at least 12.0 wt %, at least 16.4 wt %, at least 19.2 wt %, at least 22.0 wt %, at least 25.4 wt %, at least 26.7 wt %, or at least 28.8 wt % for the total weight of the coating; and/or wherein the content of the composite particles is at most 30.5 wt % for the total weight of the coating, at most 27.5 wt % at most 25.5 wt %, at most 23.5 wt %, at most 21.5 wt %, at most 19.5 wt %, at most 17.5 wt %, at most 15.0 wt %, or at most 13.0 wt % for the total weight of the coating.

Embodiment 8. The granule of any one of embodiments 1 to 7, wherein the coating comprises individual particles made of titanium dioxide in an amount of at least 0.05 wt % for a total weight of the coating, at least 0.1 wt %, at least 0.5 wt %, at least 1.0 wt %, at least 1.5 wt %, at least 2.5 wt %, at least 3.0 wt %, at least 4.5 wt %, at least 6.5 wt %, or at least 8.5 wt %, at least 10.5 wt %, at least 15.0 wt %, at least 18.0 wt %, at least 22.5 wt %, at least 25.0 wt %, at least 30.0 wt %, at least 35.0 wt %, at least 41.0 wt %, at least 46.0 wt %, or at least 50.0 wt % for the total weight of the coating; and/or wherein the content of the individual particles made of titanium dioxide is 75.0 wt. % for the total weight of the coating, at most 70 wt. %, at most 65 wt. %, at most 60 wt. %, at most 54 wt. %, at most 50 wt. %, at most 46 wt. %, at most 41 wt. %, at most 37 wt. %, at most 32 wt. %, at most 28 wt. %, at most 25 wt. %, at most 21.0 wt %, at most 17.5 wt %, at most 15.0 wt %, at most 12.0 wt %, at most 9.5 wt %, at most 7.2 wt %, at most 5.6 wt %, at most 4.2 wt %, at most 3.0 wt %, at most 2.4 wt %, at most 2.1 wt %, at most 1.8 wt %, at most 1.5 wt %, or at most 1.1 wt %, at most 0.6 wt %, at most 0.3 wt %, or at most 0.1 wt % for the total weight of the coating.

Embodiment 9. The granule of any one of embodiments 1 to 8, wherein the composite particles comprise titanium oxide, wherein the titanium dioxide contained in the composite particles is at least 0.1 wt % for a total weight of the coating, at least 0.5 wt %, at least 0.8 wt %, at least 1.1 wt %, at least 1.5 wt %, at least 1.8 wt %, at least 2.1 wt %, at least 2.6 wt %, at least 2.9 wt %, at least 3.1 wt %, at least 3.3 wt %, at least 4.5 wt %, at least 6.5 wt %, at least 8.5 wt %, at least 10.5 wt %, at least 15.0 wt %, at least 18.0 wt %, or at least 22.5 wt % for the total weight of the coating; and/or wherein the content of titanium dioxide is at most 25.0 wt % for the total weight of the coating, at most 21.0 wt %, at most 17.5 wt %, at most 15.0 wt %, at most 12.0 wt %, at most 9.5 wt %, at most 7.2 wt %, at most 5.6 wt %, at most 4.2 wt %, at most 3.2 wt %, at most 2.9 wt %, at most 2.6 wt %, at most 2.2 wt %, at most 1.9 wt %, at most 1.6 wt %, at most 1.3 wt %, at most 1.1 wt %, at most 0.9 wt %, or at most 0.7 wt % for the total weight of the coating.

Embodiment 10. The granule of any one of embodiments 1 to 9, wherein the coating comprises individual particles made of titanium oxide and an amount ratio, Ccp/Cip, wherein Ccp is an amount of the composite particles for a total weight of the coating, and Cip is an amount of the individual particles made of titanium oxide for a total weight of the coating, wherein the content ratio, Ccp/Cip, is at least 0.02:1, at least 0.06:1, at least 0.1:1, at least 0.2:1, at least 0.4:1, at least 1:1, at least 3:1, at least 5:1, at least 7:1, at least 9:1, at least 10:1, at least 14:1, at least 17:1, at least 19:1, at least 23:1, at least 26:1, at least 29:1, at least 35:1, at least 55:1, at least 70:1, at least 90:1, at least 130:1, at least 250:1, at least 350:1, at least 450:1, or at least 550:1; and/or wherein the content ratio, Ccp/Cip, is at most 600:1, at most 500:1, at most 400:1, at most 300:1, at most 200:1, at most 100:1, at most 70:1, at most 50:1, at most 35:1, at most 25:1, at most 15:1, at most 11:1, at most 8:1, at most 6:1, at most 4:1, at most 3:1, at most 2:1, at most 1:1, at most 0.5:1, or at most 0.1:1.

Embodiment 11. The granule of any one of embodiments 1 to 10, wherein the composite particles comprises titanium oxide, and wherein the coating comprises individual particles made of titanium oxide, wherein an amount ratio, Cip/Ctocp, wherein Ctocp is an amount of the titanium oxide contained in the composite particles for a total weight of the coating, and Cip is an amount of the individual particles made of titanium oxide for a total weight of the coating, wherein the content ratio, Cip/Ctocp, is greater than 0, at least 0.01:1, at least 0.1:1, at least 0.5:1, at least 0.7:1, at least 1.0:1, at least 1.5:1, at least 1.8:1, at least 2.0:1, at least 2.4:1, at least 3.0:1, at least 6:1, at least 10:1, at least 15:1, at least 25:1, at least 45:1, at least 65:1, at least 90:1, at least 115:1, at least 150:1, or at least 225:1; and/or wherein the content ratio, Cip/Ctocp, is at most 250:1, at most 210:1, at most 170:1, at most 145:1, at most 125:1, at most 85:1, at most 50:1, at most 30:1, at most 20:1, at most 17:1, at most 12:1, at most 10:1, at most 9:1, at most 7:1, at most 5.5:1, at most 3.5:1, at most 3.2:1, at most 2.8:1, at most 2.6:1, at most 2.4:1, at most 2.1:1, at most 1.8:1, at most 1.5:1, at most 1.1:1, at most 0.8:1, at most 0.7:1, at most 0.6:1, at most 0.2, or at most 0.1:1.

Embodiment 12. The granule of any one of embodiments 1 to 10, wherein the coating is essentially free of individual particles made of titanium oxide.

Embodiment 13. The granule of any one of embodiments 1 to 11, wherein the coating comprises individual particles made of titanium oxide having a first average particle size of 0.2 um to 1.5 um.

Embodiment 14. The granule of any one of embodiments 1 to 13, wherein the composite particles comprise titanium oxide particles including a second average particle size of at least 20 nm and at most 400 nm, wherein the titanium oxide particles are spaced apart from one another.

Embodiment 15. The granule of any one of embodiments 1 to 14, wherein the coating comprises individual particles made of titanium oxide having a first average particle size, and the composite particles comprise titanium-containing particles having a second average particle size, wherein a ratio of the first average particle size to the second average particle size is at least 0.5:1 and at most 75:1.

Embodiment 16. The granule of embodiment 2, wherein the at least one other oxygen-containing composition comprises an alkaline earth metal.

Embodiment 17. The granule of embodiment 1 or 16, wherein the alkaline earth metal includes comprises calcium, magnesium, or both; wherein the composite particles comprise one or more of MgCO₃, Mg₃(PO₃)₂, Ca₃(PO₃)₂, and CaCO₃.

Embodiment 18. The granule of any one of embodiments 1 to 17, wherein the composite particles comprise an amount of titanium dioxide in a range of at least 0.1 wt % and at most 25 wt % or in a range of at least 1 wt % and at most 10 wt % for a total weight of the coating or in a range of at least 1.5 wt % to 8 wt % or in a range of 2 wt % to 6 wt % for a total weight of the coating.

Embodiment 19. The granule of any one of embodiments 1 to 18, wherein the granule has a solar reflectivity of at least 20%, at least 26%, at least 33%, at least 36%, at least 39%, at least 43%, at least 46%, at least 51%, at least 55%, at least 60%, at least 65%, at least 70%, at least 75%, at least 80%, or at least 85%.

Embodiment 20. The granule of any one of embodiments 1 to 19, comprising a total content of titanium dioxide of 0.05 wt. % to 75 wt. % for a total weight of the coating.

Embodiment 21. The granule of any one of embodiments 1 to 20, wherein the coating is conformal to a shape of the granule.

Embodiment 22. The granule of any one of embodiments 1 to 21, wherein the granule has L* of at least 25 and at most 95 in the CIELAB system.

Embodiment 23. The granule of any one of embodiments 1 to 22, wherein the granule has L* of greater than 60 and at most 95 in the CIELAB system.

Embodiment 24. The granule of any one of embodiments 1 to 23, wherein the coating comprises individual particles made of titanium dioxide, wherein the coating includes a uniform dispersion of the composite particles and the individual particles made of titanium dioxide.

Embodiment 25. The granule of any one of embodiments 1 to 24, wherein the coating comprises individual particles made of titanium dioxide, wherein at least some, a majority, or essentially all of the individual particles made of titanium dioxide are spaced apart from one another.

Embodiment 26. The granule of any one of embodiments 1 to 25, wherein the coating comprises individual particles made of titanium dioxide, wherein the individual particles made of titanium dioxide have a scattered distribution pattern.

Embodiment 27. The granule of any one of embodiments 1 to 26, wherein the composite particles comprise titanium oxide particles including a scattering distance between one another of at least 150 nm, at least 180 nm, at least 230 nm, at least 280 nm, or at least 310 nm; and/or wherein the titanium dioxide particles have the scattering distance of at most 350 nm, at most 320 nm, at most 290 nm, or at most 250 nm.

Embodiment 28. The granule of any one of embodiments 25 to 27, wherein an average distance between individual particles made of titanium dioxide is in a range of at least 150 nm to 350 nm or in a range of at least 180 nm to 330 nm or in a range of at least 230 nm to 290 nm.

Embodiment 29. A roofing material, comprising the granule of any one of embodiments 1 to 28.

Embodiment 30. A construction product, comprising the granule of any one of embodiments 1 to 28, wherein the granule is at least a portion of an exterior surface of the construction product.

Embodiment 31. The granule of any one of embodiments 1 to 28, wherein the coating comprises granule coloring pigments including complex inorganic-colored pigments (CICPs), infrared-reflective pigments, UV-reflective pigments, fluorescent pigments, functional fillers, light-interference platelet pigments, metal flakes, pearlescent pigments, or any combination thereof.

Embodiment 32. The granule of any one of embodiments 1 to 28, wherein the granule is configured to be incorporated into a building material.

Embodiment 33. The granule of any one of embodiments 1 to 28, wherein the coating comprises fillers including aluminosilicates including kaolin and/or derivates thereof, calcined clay (metakaolin), dickite or nacrite, calcium carbonate, pigment spacer, pigment dispersants, coating viscosity modifiers, nano-particle additives for pigment exfoliation, or any combination thereof.

Embodiment 34. The granule of any one of embodiments 1 to 28, wherein the oxide-containing binder comprises silicates, borates, silica, zirconates, titanates, phosphate compounds, or a combination thereof.

Embodiment 35. The granule of any one of embodiments 1 to 28, wherein the oxide-containing binder comprises a silicate comprising one or more alkali metal, wherein the alkali metal is selected from lithium, sodium, potassium, or any combinations thereof.

Embodiment 36. A process of preparing a granule, comprising forming a mixture including composite particles and a fluid carrier; and applying the mixture to a surface of a core, wherein applying comprises spraying, wherein the composite particles comprise titanium-containing particles contained in an oxygen-containing binder including an alkaline earth metal.

Embodiment 37. A process of preparing a granule, comprising forming a mixture including composite particles and an oxide-containing binder material; and applying the mixture to a surface of a core, wherein forming the mixture comprises high shear mixing, and wherein the composite particles comprise titanium-containing particles.

Embodiment 38. The process of embodiment 36 or 37, wherein the composite particles comprise titanium-containing particles contained in an oxide-containing binder including an alkaline earth metal, wherein the alkaline earth metal comprises calcium, magnesium, or both.

Embodiment 39. The process of embodiment 36 or 38, wherein the oxide-containing binder including an alkaline earth metal comprises a carbonate, a phosphate, or any combination thereof.

Embodiment 40. The process of embodiment 36, 38 and 39, wherein the oxide-containing binder including an alkaline earth metal comprises magnesium carbonate, calcium carbonate, magnesium phosphate, calcium phosphate, or any combination thereof.

Embodiment 41. A process of preparing a granule, comprising:
measuring L*, a*, and b* in the CIELAB color system of a first granule comprising a first coating composition overlying at least a portion of a first core material;
adding a predetermined amount of composite particles to the first coating composition to form a second coating composition;
forming a second granule having the second coating composition overlying at least a portion of the first core material,
wherein the amount of composite particles is pre-determined based on a value of at least one of L*, a*, and b* of the first granule.

The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

### Example 1

Batches of 500 g of granules CS1, CS2, S3, and S4 were formed, respectively. The same core materials, the crushed rhyolite having a roofing grade 11 size distribution, were used for all the batches.

The mixtures of the coating compositions were made using a high-shear disperser with a high-shear impeller (Cowles blade apparatus) as follows. A 1.5″ diameter Cowles blade is used.
a) Sodium silicate and 10 wt. % of water was mixed for 30 s at speeds of 600-800 RPM (tip speeds of 1.2-1.6 m/s).
b) The composite extenders (like FP Pigments) were added next and dispersed homogeneously for a minute at 2000-3000 RPM (tips speeds of 4-6 m/s).
c) Then individual (or loose) TiO₂ particles were added and dispersed homogeneously for another minute at 2000-3000 RPM (tip speeds of 4-6 m/s).
d) Later kaolin clay or fillers were added to the mixture and dispersed homogeneously for another minute at 3000-4000 RPM (tip speeds of 6-8 m/s).
e) The colored pigments were added to the mixture next and dispersed homogeneously for a minute at 3000-4000 RPM (tip speeds of 6-8 m/s); if multiple pigments, sequentially added upon uniform color spread in the mixture.
f) After all the solid charges, the mixture was dispersed thoroughly at high speeds (5000-7000 RPM; tip speeds of 10-14 m/s) for 5-10 minutes.
g) Afterwards, remaining 90 wt. % of water was added to the dispersed mixture and blended at lower speeds of 600-800 RPM (tip speeds of 1.2-1.6 m/s) to form a homogeneous and uniform slurry.

The compositions of the respective coatings of the granules are noted in Table 1 below. The composite particles had an average particle size of 1 micron and included TiO₂ particles contained in CaCO₃. A representative composite particle has a commercial designation of FP-460. IR pigments include IR green of about 2.29 wt. % and IR Brown of about 5.47 wt. %. For forming the batches CS1 and S3, a total of 120.66 g of slurry for 500 g core particles was prepared, respectively, and core particles were spray coated in a rotary drum in the same manner for each batch, by using 60.33 g of slurry to coat 500 g of cores during each pass. For forming the batches CS2 and S4, a total of 192.84 g of slurry for 500 g of cores was made, respectively, and 96.42 g of slurry was spray coated on 500 g of cores during each pass in a rotary drum. At the end of the coating process, the coated cores were passed through a 4 ft. long rotary kiln for calcining at 500-600° C. for 10-15 mins. The single-coated, calcined granules were allowed to cool to room temperature and later evaluated for their color and performance.

TABLE 1

| Coating | | | | |
|---|---|---|---|---|
| ingredients | CS1 | S3 | CS2 | S4 |
| Liquid Sodium | 44.88 | 44.89 | 39.32 | 39.32 |
| Silicate having | | | | |
| 45 wt % of | | | | |
| solids (wt. %) | | | | |
| Water (wt. %) | 13.81 | 15.70 | 12.09 | 13.75 |
| Loose particles | 1.99 | 0.88 | 20.93 | 19.96 |
| of TiO₂ (wt. %) | | | | |
| Composite | 0.00 | 5.52 | 0.00 | 4.84 |
| particles | | | | |
| (wt. %) | | | | |
| Filler (Kaolin | 31.57 | 25.26 | 27.66 | 22.13 |
| clay) slurry | | | | |
| with 70 wt % of | | | | |
| solid (wt. %) | | | | |
| IR Pigments | 7.76 | 7.76 | / | / |
| (wt. %) | | | | |

Table 2 includes the increase (marked as “+”) or decrease (marked as “−”) in L*, a*, and b*, and solar reflectance after composite particles are used to adapt the coating formulation of CS1 to S3. In this disclosure, ΔSR is calculated using the formula, ΔSR=[(Final SR-Initial SR)/(Initial SR)]×100%. Final SR is the SR of the batch S3, and initial SR is the SR of the batch CS1. The formula for calculating color difference (ΔE) between two colors with CIELAB values as L₁*, a₁*, b₁* and L₂*, a₂*, b₂* is:

$$Δ E = \sqrt{{( {L}_{1}^{*} - {L}_{2}^{*} )}^{2} + {( {a}_{1}^{*} - {a}_{2}^{*} )}^{2} + {( {b}_{1}^{*} - {b}_{2}^{*} )}^{2}} .$$

TABLE 2

| | |
|---|---|
| ΔL* | +0.85 |
| Δa* | +0.29 |
| Δb* | +0.27 |
| ΔE | +0.94 |
| ΔSR of granules | +1.59% |
| (%) | |

Table 3 includes the increase (marked as “+”) or decrease (marked as “−”) in L*, a*, and b* and solar reflectance after composite particles are used to adapt the coating formulation of CS2 to S4.

TABLE 3

| | |
|---|---|
| ΔL* | +2.53 |
| Δa* | −0.88 |
| Δb* | −1.3 |
| ΔE | +2.98 |
| ΔSR of | +2.05% |
| granules (%) | |

Table 4 below includes the L*, a*, and b* values of CS1, CS2, S3, and S4.

TABLE 4

| | CS1 | S3 | CS2 | S4 |
|---|---|---|---|---|
| L* | 35.05 | 35.90 | 79.65 | 82.18 |
| a* | 5.54 | 5.83 | 0.68 | −0.20 |
| b* | 7.16 | 7.43 | 4.77 | 3.47 |

### Example 2

Additional batches of granules were made. The coating compositions as noted in Table 5 were prepared in the same manner as described in Example 1, except that 150 g of slurry was prepared for coating 500 g of core particles. Composite particles described in Example 1 were used. Pigments include 0.49 wt. % of IR green, 2.02 wt. % of ultramarine blue, and 4.25 wt. % of IR black. Coating the core was performed utilizing a fluidized bed coating process as follows. The core particles were coated on a benchtop, bottom-spray configuration, fluidized bed coater in batches of not more than 1000 g. The core particles were fluidized by 30 SCFM of compressed air at a temperature of 60° C. When the product temperature reached 50° C. (measured using a thermocouple setup), the coating compositions were delivered using a peristaltic pump at a flow rate of ca. 8 mL/min, atomized through a Schlick two-substance nozzle (Mod. 970, Form 0, bore size 0.8 mm, and cap setting 4) at an air pressure of 10 psi, and deposited on the fluidizing core particles over the entirety of the coating process. At the end of the coating process, the coated cores were passed through a 4 ft. long rotary kiln for calcining at 500-600° C. for 10-15 mins. The single-coated, calcined granules were allowed to cool to room temperature and later evaluated for their color and performance. As noted in Table 5, Sample CS5 had no composite particles in the coating, Sample S10 had no loose particles of TiO₂ in the coating, and Samples S6-S8 had both loose particles of TiO₂ and composite particles in the coating. All the samples included the same total content of TiO₂ in the coating compositions, which included loose particles of TiO₂ and TiO₂ in composite particles (referred to as “bound TiO₂” in Table 6).

TABLE 5

| Coating | | | | | | |
|---|---|---|---|---|---|---|
| ingredients | CS5 | S6 | S7 | S8 | S9 | S10 |
| Liquid Sodium | 37.79 | 37.79 | 37.79 | 37.79 | 37.79 | 37.79 |
| Silicate having | | | | | | |
| 40 wt % of solid | | | | | | |
| (wt. %) | | | | | | |
| Water (wt. %) | 37.79 | 37.79 | 37.79 | 37.79 | 37.79 | 37.79 |
| Loose particles | 3.12 | 2.21 | 1.30 | 0.39 | 0.03 | 0 |
| of TiO₂ (wt. %) | | | | | | |
| Composite | 0.00 | 4.54 | 9.09 | 13.63 | 15.43 | 15.58 |
| particles | | | | | | |
| (wt. %) | | | | | | |
| Filler (Kaolin | 14.54 | 10.90 | 7.27 | 3.63 | 2.19 | 2.07 |
| clay) powder | | | | | | |
| (wt. %) | | | | | | |
| IR Pigments | 6.76 | 6.76 | 6.76 | 6.76 | 6.76 | 6.76 |
| (wt. %) | | | | | | |

Table 6 includes the contents of bound TiO₂ and loose particles of TiO₂ related to the total TiO₂ and content ratios of loose particles of TiO₂ to bound TiO₂. Table 6 further includes L*, a*, and b* values of all samples, and changes to the measured properties in comparison to CS5 when the coating formulation is adapted to include composite particles for Samples S6 to S10, respectively.

TABLE 6

| | CS5 | S6 | S7 | S8 | S9 | S10 |
|---|---|---|---|---|---|---|
| Bound TiO₂ | 0 | 29.2 | 58.3 | 87.5 | 99 | 100 |
| (TiO₂ in | | | | | | |
| composite | | | | | | |
| particles) (wt. %) | | | | | | |
| relative to | | | | | | |
| total TiO₂ | | | | | | |
| Loose particles | 100 | 70.8 | 41.7 | 12.5 | 1 | 0 |
| of TiO₂ | | | | | | |
| (wt. %) relative to | | | | | | |
| total TiO₂ | | | | | | |
| Weight content | / | 2.4:1 | 0.7:1 | 0.14:1 | 0.01:1 | 0 |
| ratio of loose | | | | | | |
| particles of TiO₂ | | | | | | |
| to Bound TiO₂ | | | | | | |
| Total TiO₂ | 8.12 | 8.12 | 8.12 | 8.12 | 8.12 | 8.12 |
| (wt. %) in | | | | | | |
| the coating | | | | | | |
| L* | 35.23 | 37.45 | 40.49 | 41.66 | 41.37 | 42.45 |
| a* | 0.24 | −0.07 | −0.45 | −0.63 | −0.84 | −0.79 |
| b* | 0.63 | −1.00 | −2.21 | −2.87 | −1.68 | −2.26 |
| ΔL* | / | +2.22 | +5.26 | +6.43 | +6.06 | +7.22 |
| Δa* | / | −0.31 | −0.69 | −0.87 | −1.08 | −1.03 |
| Δb* | / | −1.63 | −2.84 | −3.50 | −2.31 | −2.89 |
| ΔE | / | +2.77 | +6.02 | +7.37 | +6.65 | +7.84 |
| TSR % | 27.3 | 28.5 | 30.7 | 28.2 | 25.1 | 26.9 |
| ΔSR of granules | / | +4.40 | +12.45 | +3.30 | −8.1 | −1.46 |
| (%) | | | | | | |

### Example 3

Additional batches of granules are to be made having the colors of red-brown (e.g., terracotta), tan/buff, black/gray, and white, respectively. A pair of batches are to be made for each color. One of the pair is to be made without composite particles, and the other of the pair is to have the adapted composition with composite particles. The coating compositions are to be prepared in a similar manner to what is described in Example 1. Composite particles described in Example 1 are to be used. Similar core particles as described in Example 1 are to be used and coated using the similar process described in Example 1. The granules are to be evaluated for their performance, such as solar reflectivity, and color changes.

The foregoing embodiments represent a departure from the state-of-the-art.

The specification and illustrations of the embodiments described herein are intended to provide a general understanding of the structure of the various embodiments. The specification and illustrations are not intended to serve as an exhaustive and comprehensive description of all the elements and features of apparatus and systems that use the structures or methods described herein. Separate embodiments may also be provided in combination in a single embodiment, and conversely, various features that are, for brevity, described in the context of a single embodiment, may also be provided separately or in any sub combination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A granule comprising:
a core; and
a coating disposed over at least a portion of the core, wherein the coating comprises composite particles dispersed in an oxide-containing binder, wherein the composite particles comprise titanium-containing particles contained in an oxygen-containing binder including an alkaline earth metal.

2. The granule of claim 1, wherein the core is unagglomerated.

3. The granule of claim 1, wherein the coating has a thickness of at least 20 microns and at most 200 microns.

4. The granule of claim 1, wherein an average particle size of the composite particles is at least 0.5 microns and at most 5 microns.

5. The granule of claim 1, comprising a ratio of a thickness of the coating to an average particle size of composite particles, Rt/sc, of at least 4:1 and at most 400:1.

6. The granule of claim 1, wherein the coating comprises the composite particles in a content of at least 0.5 wt % and at most 75 wt % based on the total weight of the coating.

7. The granule of claim 1, wherein the coating comprises individual particles made of titanium dioxide in a content of at least 0.01 wt % and less than 50.0 wt. % based on the total weight of the coating.

8. The granule of claim 1, wherein the coating comprises solar reflective pigment dispersed in the oxide-containing binder.

9. The granule of claim 1, wherein the titanium-containing particles present in the composite particles comprise titanium dioxide, wherein the titanium dioxide contained in the composite particles is at least 0.1 wt. % and at most 50 wt. % based on the total weight of the coating.

10. The granule of claim 8, wherein the solar-reflective pigment particles comprises individual titanium oxide particles, individual barium sulphate particles or a combination thereof, and wherein a ratio, Ccp/Cip, of at least 2:1 and at most 35:1, where Ccp is an amount of the composite particles based on a total weight of the coating, and Cip is an amount of the individual titanium oxide particles based on the total weight of the coating.

11. The granule of claim 1, wherein:
the titanium-containing particles in the composite particles comprise titanium dioxide, and
the coating comprises individual titanium oxide particles; and a ratio, Cip/Ctocp, is at least 0.01:1, and at most 5.5:1, wherein Ctocp is an amount of the titanium oxide contained in the composite particles based on a total weight of the coating, and Cip is an amount of the individual titanium oxide particles based on the total weight of the coating.

12. The granule of claim 11, wherein the ratio, Cip/Ctocp, is at least 0.14:1 and at most 2.5:1.

13. A construction product, comprising the granule of claim 1, wherein the granule is disposed over at least a portion of an exterior surface of the construction product.

14. A granule comprising:
a core; and
a coating disposed over at least a portion of the core, wherein the coating comprises a) composite particles dispersed in an oxide-containing binder, wherein the composite particles comprise titanium dioxide and at least one other oxygen-containing composition, and b) individual solar-reflective pigment particles dispersed in the oxide-containing binder.

15. The granule of claim 14, wherein the composite particles are present in an amount of at least 0.5 wt % and at most 30.5 wt % based on a total weight of the coating.

16. The granule of claim 14, wherein the individual titanium oxide particles have a first average particle size in a range of 0.2 um to 1.5 um.

17. The granule of claim 14, wherein the titanium oxide particles in the composite particles have a second average particle size in a range of at least 20 nm and at most 400 nm and are spaced apart from one another.

18. The granule of claim 14, wherein the at least one other oxygen-containing composition comprises an alkaline earth metal.

19. The granule of claim 14, wherein an average distance between individual solar-reflective particles is in a range of at least 150 nm to 350 nm.

20. The granule of claim 14, wherein the oxide-containing binder comprises silicates, borates, silica, zirconates, titanates, phosphate compounds, or a combination thereof.

21. The granule of claim 14, wherein the solar-reflective pigment particles comprise individual titanium oxide particles, individual barium sulphate particles, or a combination thereof.

22. A roofing product, comprising the granule of claim 14.

23. A process of preparing the granule of claim 1, comprising forming a mixture including the composite particles and a fluid carrier; and applying the mixture to a surface of the core, wherein applying comprises spraying.
